(19) United States
(12) Patent Application Publication
(10) Pub. No.: US 2020/0300306 A1
(43) Pub. Date: Sep. 24, 2020

(54) Rotary Power Coupler Assembly

(71) Applicant: Gary VanWey, Winfield, KS (US)

(72) Inventor: Gary VanWey, Winfield, KS (US)

(21) Appl. No.: 16/895,335

(22) Filed: Jun. 8, 2020

(51) Int. Cl. F16D 1/112; F16D 3/10

(52) U.S. Cl. CPC F16D 1/112; F16D 3/10

(57) ABSTRACT

A rotary power coupler assembly incorporating an axial coupler half having a first rotary axis; further incorporating an oppositely axial coupler half having a second rotary axis; further incorporating a cone and conic void joint which is connected operatively to the axial and oppositely axial coupler halves for interconnecting the axial and oppositely axial coupler halves; and further incorporating a circumferential array of V ridge and V channel joints which are connected operatively to the axial and oppositely axial coupler halves for further interconnecting the axial and oppositely axial coupler halves.

### FIELD OF THE INVENTION

This invention relates to mechanical rotary power connectors or coupler devices. More particularly, the invention relates to such devices which are adapted for alternative connection and disconnection for interchangeably translating rotary power from a motor means to a rotary power actuated implement.

### BACKGROUND OF THE INVENTION

Rotary power transmitting or translating coupling devices are known to be adapted for alternative connection and disconnection, such devices commonly including a rotary power input half and a rotary power output half. Such coupler halves are commonly adapted for engagement with each other, and typically have central axes of rotation. Upon interconnection of such halves, it is often necessary that such axes are moved into close axial alignment with each other for vibration and oscillation free co-rotation of the engaged halves.

As the halves of such common rotary power transmitting couplers are moved toward each other for engagement for rotary power transmitting use, the needed axial alignment of the halves' axes of rotation commonly does not exist. Instead, such axes often are initially angularly skewed out of alignment with each other. Such common skewing of rotation axes often interferes with proper alignment and attachment of the coupler halves, undesirably interfering with proper engagement of the coupler halves. Upon engagement of the coupler halves, the axes' misalignment may undesirably cause oscillations of the coupler halves during rotary power transmitting operation.

The instant inventive rotary power coupler assembly solves or ameliorates the problems, defects, and deficiencies of common connectable and disconnectable rotary power couplers, as described above, by dually incorporating into the coupler's halves a specially configured pin and socket joint and a circumferential array of specially configured ridge and channel joints. Such specially configured joints operate together, assisting each other in substantially automatically orienting the coupler's halves in co-axial alignment.

### BRIEF SUMMARY OF THE INVENTION

A first structural component of the instant inventive rotary power coupler assembly comprises an axial coupler half which is suitably milled or cast of steel other durable metal.

The assembly's axial coupler half has an axis of rotation (i.e., a first axis of rotation among the assembly's other rotary axes), and where the axial coupler half is cylindrically configured, as is preferred, such half's first rotary axis is preferably centrally oriented with respect to the half's circular cross sectional shape.

A further structural component of the instant inventive rotary power coupler assembly comprises an oppositely axial coupler half which is preferably configured similarly with the axial coupler half, the oppositely axial coupler half suitably being milled of steel and having a matching circular cylindrical shape. In the preferred embodiment, the oppositely axial coupler half has a similarly oriented second rotary axis.

A further structural component of the instant inventive rotary power coupler assembly comprises a pin and socket connector in the form of a cone and conic void joint which is operatively connected to or formed wholly as components of the axial and oppositely axial coupler halves. In a preferred embodiment, the cone half of the cone and conic void joint extends oppositely axially from an oppositely axial end or face of the axial coupler half, such extension preferably being along a third rotation axis which substantially coincides with or co-extends with the first rotation axis. Such joint's conic void half preferably opens axially at an axial end or face of the oppositely axial coupler half, such conic void extending oppositely axially along a fourth rotation axis which substantially co-extends with the second rotation axis.

In the preferred embodiment, the cone and conic void components of the cone and conic void joint are closely fitted for mating engagement, such joint halves having vertex angles which substantially match each other. In operation of the inventive coupler, such matching of vertex angles advantageously allows the conic joint halves to perform an automatic axial alignment function during coupler engagement.

A further structural component of the instant inventive rotary power coupler assembly comprises a circumferential array of V ridge and V channel joints. In the preferred embodiment, the ridges and joints among such circumferential array are evenly circumferentially spaced. Similarly with the matching vertex angles of the assembly's cone and conic void joint, the circumferentially arrayed V ridge and V channel joints have matching vertex angles. The matching vertex angles of the V ridge and V channel joints assist or compliment the cone and conic void joint's automatic coupler half alignment function.

During assembly of the instant inventive assembly for rotary power translating use, the cone half of the coupler's cone and conic void joint may be initially oppositely axially extended so that its vertex or point enters the axial opening of the conic void. In the event of misalignment of the axial and oppositely axial coupler halves' first and second rotation axes, the vertex or point of such cone may advantageously contact a peripheral wall of the conic void, allowing a sliding engagement of such vertex or point therealong to substantially automatically guide the axial coupler half into a proper co-extending alignment with the oppositely axial coupler half.

Substantially simultaneously with such coupler half engagement, vertex points of the V ridge and V channel joints enter the V channels perform further axial aligning functions as compliments to and in assistance of the above described axial aligning function of the cone and conical void joint.

Upon full nesting receipts of the cone within the conic void and of the V ridges within their V channels, the coupler's axial and oppositely axial halves are advantageously automatically aligned with each other for proper and oscillation free rotary power translation. Upon performing their alignment assisting functions, the V ridges of the circumferential array of V ridge and V channel joints remain in operative engagement with the V channels for rotary power translation.

Accordingly, objects of the instant invention include the provision of a rotary power coupler assembly which incorporates structures, as described above, and which arranges those structures in manners described above for the achievement and performance of beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a side view of a preferred embodiment of the instant inventive rotary power coupler assembly.

FIG. 2 redepicts an axial coupler half component half of the structure of FIG. 1.

FIG. 3 depicts an oppositely axial coupler half of the structure depicted in FIG. 1.

FIG. 4 is a sectional view as indicated in FIG. 2.

FIG. 5 is a sectional view as indicated in FIG. 3.

FIG. 6 depicts the structure of FIG. 4 moving into engagement with the structure of FIG. 5.

FIG. 7 is a magnified view of a portion of the FIG. 6 structure, as indicated in FIG. 6.

### DETAILED DESCRIPTION OF A PREFERRED EMBODIMENT

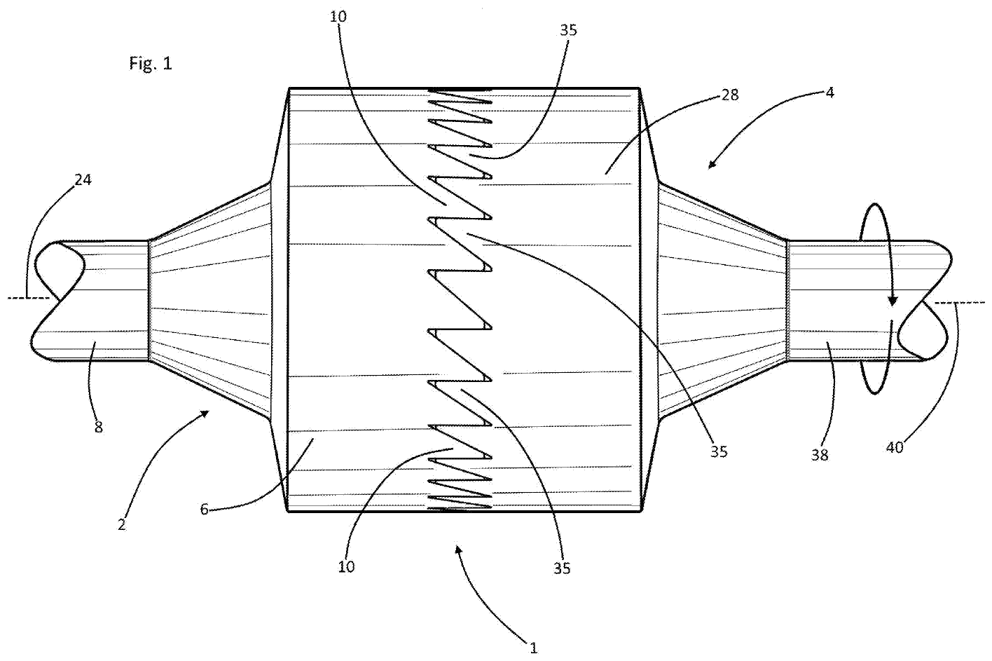

Referring now to the drawings and in particular to Drawing FIG. 1, a preferred embodiment of the instant inventive rotary power coupler assembly is referred to generally by Reference Arrow 1. The coupler assembly 1 has a circular cylindrical axial coupler half which is referred to generally by Reference Arrow 2, and has a matching circular cylindrical oppositely axial coupler half which is referred to generally by Reference Arrow 4. The axial coupler half 2 has a cylindrical body 6, and the oppositely axial coupler half 4 has a preferably matching cylindrical body 28. Rotary power input and output shafts 8 and 38 respectively extend to an axial end of the axial body 6 and from an oppositely axial end of the oppositely axial body 28.

An axial end of the rotary power input shaft 8 preferably extends to and communicates with a motor means source of rotary power such as an electric motor or a reciprocating piston internal combustion engine (such motor means not being depicted). An oppositely axial end of the rotary power output shaft 38 preferably extends to and communicates with a rotary powered implement such as a mower, a lawn edger, a garden tiller, or a snow blower (such implements also not being depicted).

First and second axes of rotation 24 and 40 preferably extend longitudinally and substantially centrally through the cylindrically figured coupler halves, bodies, and shafts 2,6,8 and 4,28,38.

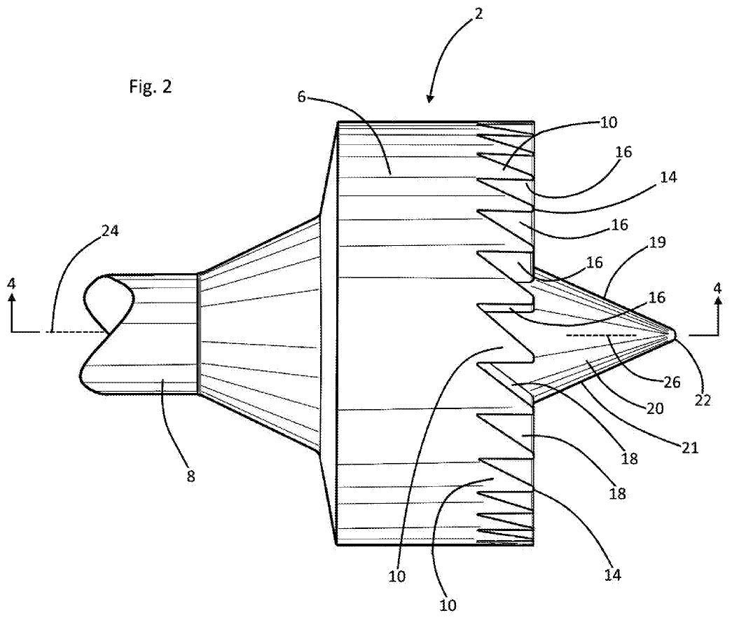

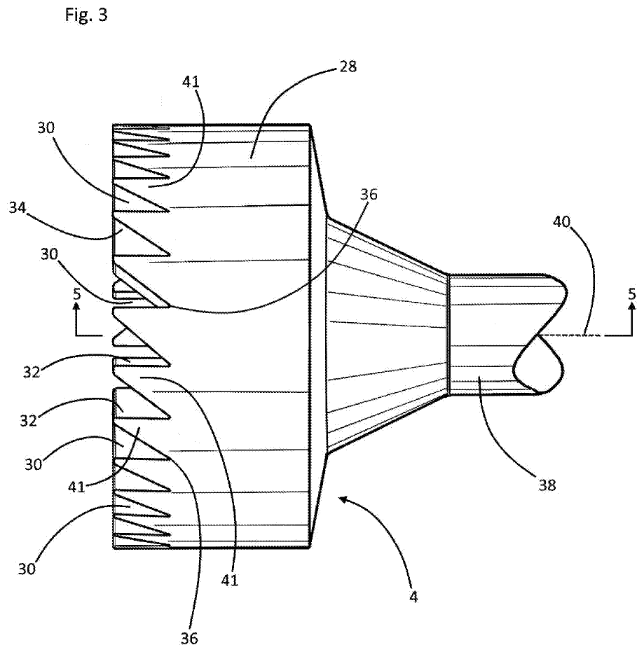

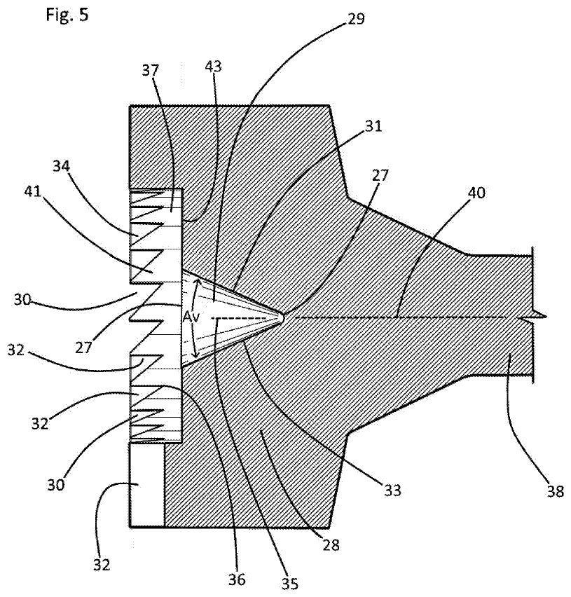

Referring simultaneously to FIGS. 1-7, the instant inventive rotary power coupler assembly 1 preferably further comprises a specialized pin and socket connector in the form of a cone and conic void joint 20,29. The cone portion 20 of such joint has a third rotation axis 26, and such joint's conic void portion 29 has a fourth rotation axis 35. In the preferred embodiment, the third rotation axis 26 substantially coincides with or co-extends with the first rotation axis 24, and the fourth rotation axis 35 substantially coincides or co-extends with the second rotation axis 40. The cone 20 has an oppositely axially extending vertex 22, and the conic void 29 similarly has an oppositely axially extended vertex 27. A first vertex angle “Ac” between diametrically opposed conic wall surfaces 19 and 21 preferably substantially matches a second vertex angle “Av” between diametrically opposed wall surfaces 31 and 33 of the conic void 29. In the preferred embodiment, such first and second vertex angles “Ac” and “Av” are substantially matching or equal to each other.

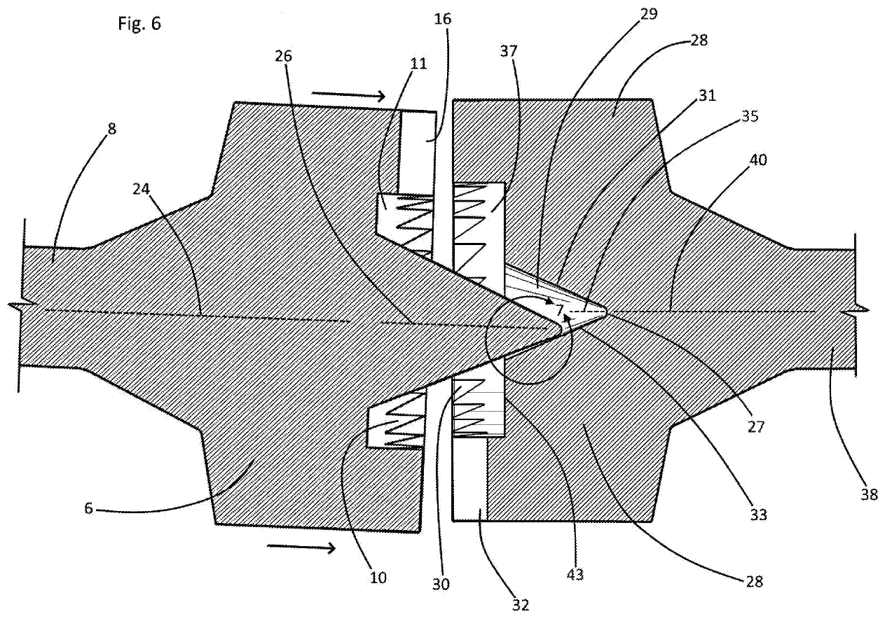

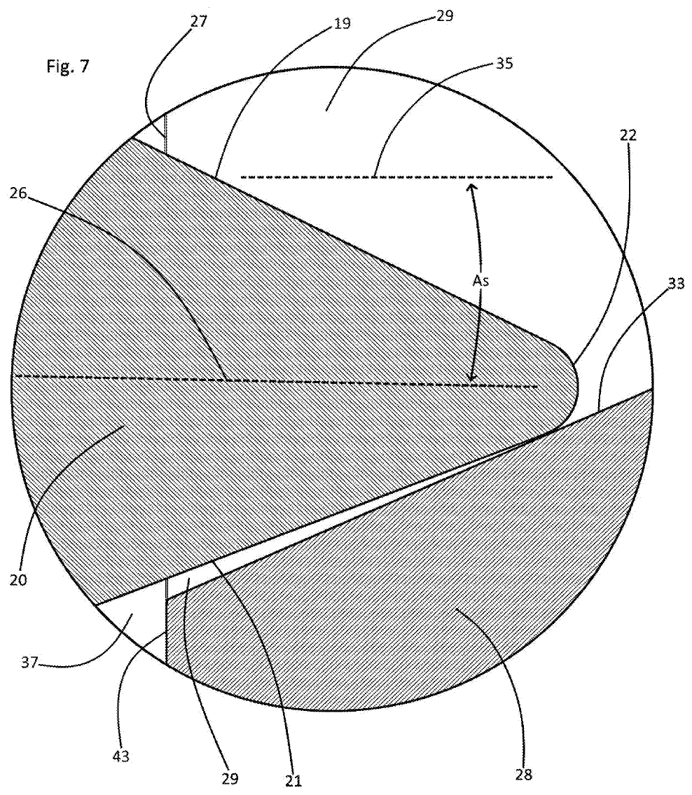

Referring in particular to FIGS. 6 and 7, as the axial coupler half is moved (either mechanically or manually) toward the oppositely axial coupler half, the vertex 22 of cone 20 may enter the axial opening 27 of the conic void 29. Thereafter, vertex 22 may, as a result in inaccuracies in engaging movements of the coupler halves, impinge against a conic void wall surface (surface 33, for example) as indicated in FIG. 7. Upon such contact, such wall surface 33 effectively drives the cone 20 and its third rotation axis 26 toward the fourth rotation axis 35 of conic void 29. As such motion of the axial coupler half continues in the direction of the arrows drawn upon FIG. 6, vertex 22 may progressively slide in the oppositely axial direction along wall surface 33 until cone 20 nestingly seats within conic void 29. To facilitate such sliding motion, it is preferred that such conic void wall surface (surfaces 31 and 33 being examples) constitute and function as a substantially flat or linear slide channel floor extending from opening 27 to vertex 22. Such sliding contact of vertex 22 along surface 33 toward vertex 27 effectively rotates the axial coupler half counter clockwise (according to the view of FIG. 6) with respect to the oppositely axial coupler half, such relative rotation advantageously eliminating any axial skew angle “As” which may arise during the process of coupler half engagement. Accordingly, the cone 20 and conic void 29 components work together to automatically orient the first rotation axis 24, the second rotation axis 40, the third rotation axis 26, and the fourth rotation axis 35 as co-extending lines.

Further structural components of the instant inventive rotary power coupler assembly comprise a circumferential array of V ridge and V channel joints, such joints being operatively attached to or milled as components of the axial and oppositely axial coupler halves 2 and 4. V ridge components 10 of such V ridge and V channel joints have vertexes 14 which extend oppositely axially from an oppositely axial end of the axial coupler half's body 6. A corresponding circumferential array of V channels 30 open axially at an axial end of the body 28 of the oppositely axial coupler half 4, the hollow voids of such channels 30 extending oppositely axially to vertex points 36. In the preferred embodiment, the V ridge 10 and V channel 30 joints are circumferentially arrayed, and are substantially evenly circumferentially spaced.

Simultaneously with the above described nesting receipt by the conic void 29 of the cone 20, the vertices 14 of the V ridges 10 extend into and are similarly nestingly received within V channels 30. Third vertex angles of the V ridges 10 (suitably approximately 45°) preferably match the vertex angles of the V channels 30 so that the insertions of the V ridges 10 into the V channels 30 may guide and axially align the coupler halves 2 and 4 in a manner which mechanically assists the automatic axial aligning function of the cone 20 and conic void 29. Accordingly, the matched and nesting V configurations of the cone 20, the conic void 29, the V ridges 10, and the V channels 30 work together and functionally compliment each other in their performance of the automatic aligning function which advantageously orients the coupler halves to align and co-extend their first 24, third 26, second 40, and fourth 35 rotation axes.

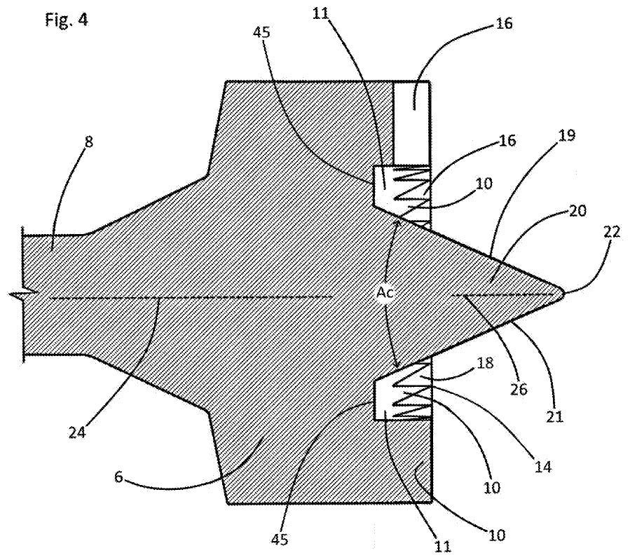

In the preferred embodiment, the oppositely axial coupler half's the conic void 29 and such half's axially extending teeth 41 (which circumferentially define the V channels 30) respectively extend oppositely axially and axially from a floor 43 of an axially opening recess 37 which is formed at the axial end of the oppositely axial coupler half. Correspondingly, the axial half's V ridges 10 and cone 20 extend oppositely axially from a floor 45 of an oppositely axially opening recess 11 which is formed at the oppositely axial end of the axial coupler half 2. As shown in FIG. 4, the oppositely axial extension of cone 20 substantially exceeds the oppositely axial extensions of the V ridges 10, such extension differential allowing for simultaneous cone and ridge engagements within the void 29 and within the V channels 30.

In a preferred embodiment, the V ridges 10 and the V channels 30 are configured for maximal translation of rotary power which is exerted in the circumferential direction as indicated by the elliptical arrow drawn upon FIG. 1. Upon a reversal of such rotary power, the V ridges 10 preferably become axially extracted from the V channels 30, resulting in disengagement of the coupler halves 2 and 4. Accordingly, the inventive coupler facilitates one way power transfer in the circumferential direction.

To facilitate circumferential power transfer, the circumferential faces 16 of the V ridges 10 are preferably oriented within or co-extend with first planes which include the first and third rotation axes 24 and 26. Correspondingly, the oppositely circumferential faces 32 of the V channels 30 are aligned with or co-extend with second planes which include rotation axes 35 and 40. The opposite faces 18 of the V ridges 10, and opposite faces 34 of axially extending teeth 41 are preferably angled at approximately 45° with respect to the first and second planes. Such angular orientations assure that, upon a commencement of counter circumferential rotation of the axial coupler half 2 with respect to the oppositely axial coupler half 4, their angled and abutting faces 18 and 34 together function as slide ramps or planes which drive the coupler halves out of engagement. Accordingly, the instant inventive coupler assembly advantageously facilitates one way or exclusively circumferentially directed power transmission, while disengaging and terminating power transfer at an onset of counter circumferentially directed rotary power.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A rotary power coupler assembly comprising:
(a) an axial coupler half having a first rotary axis;
(b) an oppositely axial coupler half having a second rotary axis;
(c) a cone and conic void joint, said joint interconnecting the axial and oppositely axial coupler halves; and
(d) a circumferential array of V ridge and V channel joints, said array of joints further interconnecting the axial and oppositely axial coupler halves.

2. The rotary power coupler assembly of claim 1 wherein the cone and conic void joint's cone has a third rotary axis, said axis substantially co-extending with the first rotary axis.

3. The rotary power coupler assembly of claim 2 wherein the cone and conic void joint's conic void has a fourth rotary axis, said axis substantially co-extending with the second rotary axis.

4. The rotary power coupler assembly of claim 3 wherein each V ridge among the circumferential array of V ridge and V channel joints has a circumferential face, said face substantially co-extending with a plane including the first rotary axis.

5. The rotary power coupler assembly of claim 4 wherein each V channel among the circumferential array of V ridge and V channel joints has a counter circumferential face, said face substantially co-extending with a plane including the second rotary axis.

6. The rotary power coupler assembly of claim 5 wherein the V ridge and V channel joints are substantially evenly circumferentially spaced.

7. The rotary power coupler assembly of claim 6 wherein said each V ridge has an oppositely axial extension, wherein the cone has an oppositely axial extension, and wherein the cone's oppositely axial extension is greater than that of said each V ridge.

8. The rotary power coupler assembly of claim 7 wherein the cone has a first vertex angle, wherein the conic void has a second vertex angle, and wherein said first and second vertex angles are substantially equal.

9. The rotary power coupler assembly of claim 8 wherein said each of V ridge has a third vertex angle, wherein said each V channel has a fourth vertex angle, and wherein said third and fourth vertex angles are substantially equal.
